(19) United States
(12) Patent Application Publication
(10) Pub. No.: US 2024/0376280 A1
(43) Pub. Date: Nov. 14, 2024

(54) GAS-BARRIER LAMINATE, PACKAGING FILM, PACKAGING CONTAINER, AND PACKAGED PRODUCT

(71) Applicant: TOPPAN Holdings Inc., Taito-ku, Tokyo (JP)

(72) Inventors: Ayumi TANAKA, Taito-ku, Tokyo (JP); Takeshi NISHIKAWA, Taito-ku, Tokyo (JP); Miki FUKUGAMI, Taito-ku, Tokyo (JP)

(73) Assignee: TOPPAN Holdings Inc., Taito-ku, Tokyo (JP)

(21) Appl. No.: 18/696,423

(22) PCT Filed: Sep. 26, 2022
(86) PCT No.: PCT/JP2022/035678

§ 371 Date: Mar. 28, 2024

(30) Foreign Application Priority Data
Sep. 30, 2021 (JP) 2021-160341

(51) Int. Cl. C08J 7/048; B29C 71/02; C08J 7/04; C08J 7/043; C08K 3/36; C08K 5/5419

(52) U.S. Cl. CPC C08J 7/048; C08J 7/0423; C08J 7/043; C08K 3/36; C08K 5/5419; C08J 7/08; C08J 2329/04; C08J 2367/02; C08J 2375/04

(57) ABSTRACT

A gas barrier laminated body including a base material layer including a thermoplastic resin, a metal oxide layer, and a gas barrier coating layer in this order, in which on a surface of the gas barrier coating layer, a ratio (Si/C) of silicon atoms and carbon atoms as measured by X-ray photoelectron spectroscopy is greater than 0 and less than 0.50.

### TECHNICAL FIELD

The present disclosure relates to a gas barrier laminated body, a packaging film, a packaging container, and a packaged product.

### BACKGROUND ART

In packaging containers such as packaging bags used for packaging foods, pharmaceutical products, and the like, gas barrier properties that block the entry of water vapor, oxygen, and other gases deteriorating the contents, are required in order to suppress deterioration, decay, and the like of the contents and to maintain the functions and properties of the contents. Accordingly, gas barrier laminated bodies have been conventionally used in these packaging bags.

A gas barrier laminated body generally includes a base material layer, a metal oxide layer, and a gas barrier coating layer in this order, and the gas barrier coating layer is formed by applying a gas barrier coating layer-forming composition that can impart a gas barrier function on the metal oxide layer and curing the composition.

As such a gas barrier laminated body, various laminated bodies have been hitherto developed.

For example, in the following Patent Literature 1, it has been proposed to improve oxygen barrier properties and the like by using a transparent laminated body in which a transparent primer layer formed from a mixture of an acrylic resin and an isocyanate resin, a thin film layer formed of an inorganic compound, and a gas barrier film layer are laminated in sequence on a base material formed of a transparent plastic, in which the gas barrier film is a layer formed by applying a coating agent containing an aqueous solution or a water/alcohol mixed solution, both of which include an aqueous polymer and at least one of (a) one or more kinds of metal alkoxides and hydrolysates thereof or (b) tin chloride as main agents, and heating and drying the coating agent.

### CITATION LIST

### Patent Literature

Patent Literature 1: Japanese Unexamined Patent Publication No. H10-264292

### SUMMARY OF INVENTION

### Technical Problem

However, the gas barrier laminated body described in the above-described Patent Literature 1 has the following problems.

That is, the gas barrier laminated body described in the Patent Literature 1 has room for improvement in view of improving the oxygen barrier properties after ill-treatment.

It is an object of the present disclosure to provide a gas barrier laminated body that can improve oxygen barrier properties after ill-treatment, a packaging film, a packaging container, and a packaged product.

### Solution to Problem

The present disclosure is a gas barrier laminated body including a base material layer including a thermoplastic resin, a metal oxide layer, and a gas barrier coating layer in this order, in which a ratio (Si/C) of silicon atoms with respect to carbon atoms on a surface of the gas barrier coating layer, as measured by X-ray photoelectron spectroscopy, is greater than 0 and less than 0.50.

According to the gas barrier laminated body of the present disclosure, the oxygen barrier properties after ill-treatment can be improved.

The reason why such an effect is obtained by the gas barrier laminated body of the present disclosure is not clearly understood; however, it is speculated to be because flexibility of the gas barrier coating layer is further improved by setting the ratio (Si/C) of silicon atoms with respect to carbon atoms as measured by X-ray photoelectron spectroscopy to be greater than 0 and less than 0.50, in addition to allowing the base material layer to include a thermoplastic resin.

It is preferable that the above-described gas barrier laminated body further includes an anchor coat layer between the base material layer and the metal oxide layer.

In this case, the smoothness of the surface of the anchor coat layer is improved more than the smoothness of the surface of the base material layer. Therefore, it is possible to make the thickness of the metal oxide layer uniform, and the gas barrier properties of the gas barrier laminated body can be further improved.

In the above-described gas barrier laminated body, it is preferable that the gas barrier coating layer is formed of a cured product of a composition including a water-soluble polymer and at least one selected from the group consisting of a silicon alkoxide represented by the following General Formula (1) and a hydrolysate thereof, and when the amount of the silicon alkoxide in the composition is calculated in terms of SiO₂, the content percentage of the water-soluble polymer in the solid content is 40% by mass or greater.

Si(OR¹)₄ (1)

wherein in the General Formula (1), R¹ represents an alkyl group or —C₂H₄OCH₃.

In this case, flexibility of the gas barrier laminated body can be further improved. Therefore, the oxygen barrier properties of the gas barrier laminated body after ill-treatment can be further improved.

In the above-described gas barrier laminated body, it is preferable that when the amount of the silicon alkoxide in the composition is calculated in terms of SiO₂, the content percentage of the water-soluble polymer in the solid content is 43% by mass or greater and 85% by mass or less.

In this case, the oxygen gas barrier properties of the gas barrier laminated body after ill-treatment can be further improved as compared to the case where the content percentage of the water-soluble polymer in the solid content is less than 43% by mass. In addition, the interlayer adhesion in the gas barrier laminated body after a retort treatment can be further improved as compared to the case where the content percentage of the water-soluble polymer in the solid content is greater than 85% by mass.

In the above-described gas barrier laminated body, it is preferable that the gas barrier coating layer further includes a silane coupling agent, and the silane coupling agent includes at least one selected from the group consisting of a silicon compound represented y the following General Formula (2) and a hydrolysate thereof.

(R²Si(OR³)₃)ₙ (2)

wherein in the General Formula (2), R² represents a monovalent organic functional group, and R³ represents an alkyl group or —C₂H₄OCH₃. n represents an integer of 1 or greater.

In this case, it is possible to improve close adhesion between the gas barrier coating layer and the metal oxide layer, and the interlayer detachment in the gas barrier laminated body can be suppressed.

In the above-described gas barrier laminated body, it is preferable that the thickness of the metal oxide layer is 5 nm or greater and 80 nm or less.

In this case, the oxygen barrier properties of the gas barrier laminated body are further improved as compared to the case where the thickness of the metal oxide layer is less than 5 nm. In addition, the flexibility of the gas barrier laminated body further improves as compared to the case where the thickness of the metal oxide layer is greater than 80 nm, and the oxygen barrier properties of the gas barrier laminated body after ill-treatment can be further improved. Furthermore, the oxygen barrier properties of the gas barrier laminated body after a retort treatment can also be further improved.

In the above-described gas barrier laminated body, it is preferable that the thickness of the gas barrier coating layer is 50 nm or greater and 700 nm or less.

In this case, the oxygen barrier properties of the gas barrier laminated body are further improved as compared to the case where the thickness of the gas barrier coating layer is less than 50 nm. In addition, the flexibility of the gas barrier laminated body further improves as compared to the case where the thickness of the gas barrier coating layer is greater than 700 nm, and the oxygen barrier properties of the gas barrier laminated body after ill-treatment can be further improved. Furthermore, the oxygen barrier properties of the gas barrier laminated body after a retort treatment can be further improved.

In the above-described gas barrier laminated body, it is preferable that the thickness of the anchor coat layer is 30 nm or greater and 300 nm or less.

In this case, it is possible to further improve the smoothness of the surface of the anchor coat layer more than the surface of the base material layer as compared with the case where the thickness of the anchor coat layer is less than 30 nm, it is possible to make the thickness of the metal oxide layer more uniform, and at the same time, the oxygen barrier properties can also be further improved. For this reason, the oxygen barrier properties of the gas barrier laminated body can be even further improved. In addition, the flexibility of the gas barrier laminated body further improves as compared to the case where the thickness of the anchor coat layer is greater than 300 nm, and the oxygen gas barrier properties of the gas barrier laminated body after ill-treatment can be further improved.

In the above-described gas barrier laminated body, it is preferable that the thickness of the base material layer is 40 μm or less.

In this case, the flexibility of the gas barrier laminated body further improves as compared to the case where the thickness of the base material layer is greater than 40 μm, and the oxygen gas barrier properties of the gas barrier laminated body after ill-treatment can be further improved.

In addition, the present disclosure is a packaging film including the above-described gas barrier laminated body and a sealant layer.

Since this packaging film includes the above-described gas barrier laminated body, the oxygen barrier properties after ill-treatment can be improved.

Furthermore, the present disclosure is a packaging container including the above-described packaging film.

Since this packaging container includes the above-described packaging film, the oxygen barrier properties after ill-treatment can be improved.

Moreover, the present disclosure is a packaged product including the above-described packaging container and contents filled in the packaging container.

Since this packaged product includes the above-described packaging container, and the packaging container can improve the oxygen barrier properties after ill-treatment, deterioration in the quality of the contents caused by oxygen contamination can be suppressed over a long period of time.

### Advantageous Effects of Invention

According to the present disclosure, there are provided a gas barrier laminated body, a packaging film, a packaging container, and a packaged product, all of which can improve the oxygen barrier properties after ill-treatment.

### BRIEF DESCRIPTION OF DRAWINGS

FIG. 1 is a cross-sectional view illustrating an embodiment of a gas barrier laminated body of the present disclosure.

FIG. 2 is a cross-sectional view illustrating an embodiment of a packaging film of the present disclosure.

FIG. 3 is a cross-sectional view illustrating an embodiment of a packaged product of the present disclosure.

### DESCRIPTION OF EMBODIMENTS

Hereinafter, embodiments of the present disclosure will be described in detail.

### <Gas Barrier Laminated Body>

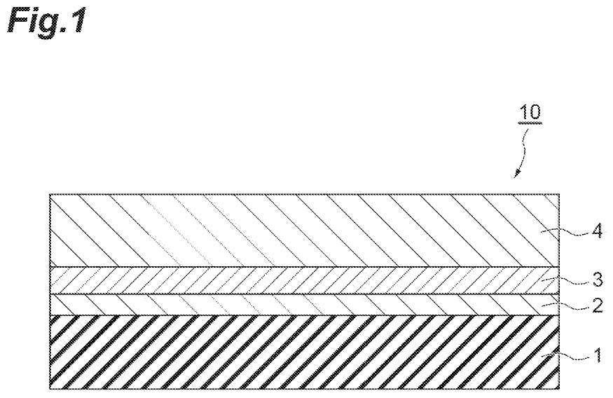

First, an embodiment of a gas barrier laminated body of the present disclosure will be described with reference to FIG. 1. FIG. 1 is a cross-sectional view illustrating an embodiment of the gas barrier laminated body of the present disclosure. In FIG. 1, the gas barrier laminated body 10 includes a base material layer 1 including a thermoplastic resin, a metal oxide layer 3, and a gas barrier coating layer 4 in this order. On the surface of the gas barrier coating layer 4, the ratio (Si/C) of silicon atoms with respect to carbon atoms as measured by X-ray photoelectron spectroscopy (XPS) is greater than 0 and less than 0.50. Incidentally, the gas barrier laminated body 10 may have an anchor coat layer 2 between the base material layer 1 and the metal oxide layer 3.

This gas barrier laminated body 10 can improve the oxygen barrier properties after ill-treatment.

Hereinafter, the base material layer 1, the anchor coat layer 2, the metal oxide layer 3, and the gas barrier coating layer 4 will be described in detail.

### (Base Material Layer)

The base material layer 1 is a layer that serves as a support for the gas barrier coating layer 4 and includes a thermoplastic resin. Examples of the thermoplastic resin include a polyolefin resin, a polyester resin, a polyamide resin, a polyether resin, an acrylic resin, and a natural polymer compound (cellulose acetate or the like). These may be used singly or as mixtures composed of two or more kinds thereof.

Among them, the thermoplastic resin is preferably a polyolefin resin or a polyester resin.

Examples of the polyolefin resin include polyethylene and polypropylene, and from the viewpoint of the resistance to a retort treatment, polypropylene is preferred. Here, the polypropylene may be a homopolypropylene or a propylene copolymer; however, from the viewpoint of the oxygen barrier properties, it is more preferable that the polypropylene constituting at least the surface layer on the gas barrier coating layer 4 side of the base material layer 1 is a polypropylene copolymer. Examples of the polyester resin include a polyethylene terephthalate resin (PET) and a polyethylene naphthalate resin (PEN).

The base material layer 1 may be a stretched film or may be a non-stretched film, and from the viewpoint of the oxygen barrier properties, the base material layer 1 is preferably a stretched film. Here, examples of the stretched film include a uniaxially stretched film and a biaxially stretched film; however, a biaxially stretched film is preferred from the viewpoint of improving heat resistance.

The thickness of the base material layer 1 is not particularly limited; however, for example, the thickness may be 0.1 mm or less. Above all, the thickness of the base material layer 1 is preferably 40 μm or less, more preferably 35 μm or less, and particularly preferably 30 μm or less. When the thickness of the base material layer 1 is 40 μm or less, the flexibility of the gas barrier laminated body 10 further improves as compared with the case where the thickness of the base material layer 1 is greater than 40 μm, and the oxygen gas barrier properties of the gas barrier laminated body 10 after ill-treatment can be further improved. However, from the viewpoint of improving strength, the thickness is preferably 10 μm or greater, and more preferably 12 μm or greater.

The base material layer 1 may also include additives such as an antistatic agent, an ultraviolet absorber, a plasticizer, and a lubricating agent, as needed.

### (Anchor Coat Layer)

The anchor coat layer 2 is a layer for further improving close adhesion between the base material layer 1 and the metal oxide layer 3, and is provided between the base material layer 1 and the metal oxide layer 3.

The material constituting the anchor coat layer 2 is not particularly limited as long as it is capable of improving close adhesion between the base material layer 1 and the metal oxide layer 3; however, these materials may include a reaction product of an organosilane or an organic metal compound, a polyol compound, and an isocyanate compound. That is, it can also be said that the anchor coat layer 2 is a urethane-based adhesive layer. The organosilane is, for example, a trifunctional organosilane or a hydrolysate of a trifunctional organosilane. The organic metal compound is, for example, a metal alkoxide or a hydrolysate of a metal alkoxide. Examples of the metal element included in the organic metal compound include Al, Ti, and Zr. The hydrolysate of the organosilane and the hydrolysate of the metal alkoxide may respectively have at least one hydroxyl group. From the viewpoint of transparency, the polyol compound is preferably an acrylic polyol. The isocyanate compound mainly functions as a crosslinking agent or a curing agent. The polyol compound and the isocyanate compound may be monomers or may be polymers.

The thickness of the anchor coat layer 2 is not particularly limited as long as it is a thickness at which close adhesion between the base material layer 1 and the metal oxide layer 3 can be improved; however, the thickness is preferably 30 nm or greater. In this case, it is possible to improve the smoothness of the surface of the anchor coat layer 2 more than the surface of the base material layer 1 as compared with the case where the thickness of the anchor coat layer 2 is less than 30 nm, and it is possible to make the thickness of the metal oxide layer 3 more uniform, while at the same time, the oxygen barrier properties can also be further improved. Therefore, the oxygen barrier properties of the gas barrier laminated body 10 can be even further improved. The thickness of the anchor coat layer 2 is more preferably 40 nm or greater, and even more preferably 50 nm or greater. By increasing the thickness of the anchor coat layer 2, deterioration of the water vapor barrier properties in a case where an external force such as stretching is applied can be further suppressed. The thickness of the anchor coat layer 2 is preferably 300 nm or less. In this case, the flexibility of the gas barrier laminated body 10 further improves as compared to the case where the thickness of the anchor coat layer 2 is greater than 300 nm, and the oxygen gas barrier properties of the gas barrier laminated body 10 after ill-treatment can be further improved. The thickness of the anchor coat layer 2 is more preferably 200 μm or less.

### (Metal Oxide Layer)

The metal oxide layer 3 is a layer including a metal oxide. As the gas barrier laminated body 10 has a metal oxide layer 3, the gas barrier properties can be further improved.

As the metal constituting the metal oxide, at least one atom selected from the group consisting of Si, Al, Mg, Sn, Ti, and In may be exemplified. From the viewpoint of the water vapor barrier properties, the metal oxide is preferably SiOₓ or AlOₓ. Above all, the metal oxide is preferably SiOₓ. In this case, the gas barrier laminated body 10 can have more excellent water vapor barrier properties.

The metal oxide layer 3 may be composed of a single layer, or may be composed of a plurality of layers.

The thickness of the metal oxide layer 3 is not particularly limited; however, the thickness is preferably 5 nm or greater. In this case, the oxygen barrier properties of the gas barrier laminated body 10 are further improved as compared to the case where the thickness of the metal oxide layer 3 is less than 5 nm. The thickness of the metal oxide layer 3 is more preferably 8 nm or greater, and particularly preferably 10 nm or greater.

In addition, the thickness of the metal oxide layer 3 is preferably 80 nm or less. In this case, the flexibility of the gas barrier laminated body 10 further improves as compared to the case where the thickness of the metal oxide layer 3 is greater than 80 nm, and the oxygen barrier properties of the gas barrier laminated body 10 after ill-treatment can be further improved. Furthermore, the oxygen barrier properties of the gas barrier laminated body 10 after a retort treatment can also be further improved. The thickness of the metal oxide layer 3 is more preferably 70 nm or less, and particularly preferably 60 nm or less.

### (Gas Barrier Coating Layer)

The gas barrier coating layer 4 is composed of a cured body of a gas barrier coating layer-forming composition. On the surface of the gas barrier coating layer 4, the ratio of silicon atoms with respect to carbon atoms (hereinafter, also referred to as “Si/C”) as measured by X-ray photoelectron spectroscopy (hereinafter, also referred to as “XPS”) is greater than 0 and less than 0.50. In this case, the oxygen barrier properties of the gas barrier laminated body 10 after ill-treatment can be improved as compared to the case where Si/C is 0.50 or greater.

The Si/C obtained by XPS is determined by performing a narrow analysis under the following measurement conditions by using the following measurement instrument to acquire a spectrum, and calculating the ratio of Si and C from this spectrum. The ratio of silicon atoms with respect to carbon atoms (Si/C) is a molar ratio.

### <Measurement Instrument>

Manufactured by JEOL Ltd., JPS-9030 type photoelectron spectroscopy

### <Measurement Conditions>

### (Conditions for Spectrum Collection)

Incident X-rays: MgKα (monochromatized X-rays, hν=1253.6 eV)

X-ray output: 10 W (10 kV·10 mA)

X-ray scanning area (measurement region): Circular region having a diameter of 6 mm

Photoelectron uptake angle: 90°

The Si/C obtained by XPS is preferably 0.48 or less, and more preferably 0.45 or less. The Si/C may be 0.40 or less, 0.35 or less, or 0.30 or less. The Si/C obtained by XPS may be greater than 0, or may be 0.05 or greater, 0.08 or greater, 0.10 or greater, or 0.12 or greater. From the viewpoint of improving close adhesion to the metal oxide layer 3 after a retort treatment, the Si/C obtained by XPS is preferably 0.15 or greater.

The gas barrier coating layer-forming composition includes a water-soluble polymer and at least one selected from the group consisting of a silicon alkoxide and a hydrolysate thereof. The silicon alkoxide is represented by the following General Formula (1): Si(OR¹)₄.

Si(OR¹)₄ (1)

In General Formula (1), R′ represents an alkyl group or —C₂H₄OCH₃. Examples of the alkyl group include a methyl group and an ethyl group. Above all, an ethyl group is preferred. In this case, silicon alkoxide becomes tetraethoxysilane, and after being hydrolyzed, silicon alkoxide can be made relatively stable in a water-based solvent.

Examples of the water-soluble polymer include a polyvinyl alcohol resin, a modification product thereof, and polyacrylic acid. These can be used singly or in combination of two or more kinds thereof. Above all, the water-soluble polymer is preferably a polyvinyl alcohol resin or a modification product thereof. In this case, this composition can impart, when cured, more excellent gas barrier properties to the gas barrier laminated body 10. In addition, this composition can impart, even when cured, more excellent flexibility to the gas barrier laminated body 10 and can further improve the oxygen barrier properties after ill-treatment.

In a case where the water-soluble polymer is composed of a polyvinyl alcohol resin or a modification thereof, the degree of saponification of the water-soluble polymer is not particularly limited; however, from the viewpoint of improving the gas barrier properties of the gas barrier laminated body 10, the degree of saponification is preferably 95% or greater, or may be 100%.

The degree of polymerization of the water-soluble polymer is not particularly limited; however, from the viewpoint of improving the gas barrier properties of the gas barrier laminated body 10, the degree of polymerization is preferably 300 or greater. The degree of polymerization of the water-soluble polymer is preferably 450 to 2400.

The content percentage of the water-soluble polymer in the solid content is not particularly limited; however, in a case where the amount of silicon alkoxide is calculated in terms of SiO₂, the content percentage is preferably 40% by mass or greater. In this case, the flexibility of the gas barrier laminated body 10 can be further improved. For this reason, the oxygen barrier properties of the gas barrier laminated body 10 after ill-treatment can be further improved.

The content percentage of the water-soluble polymer in the solid content is preferably 43% by mass or greater, more preferably 44% by mass or greater, and particularly preferably 45% by mass or greater. When the content percentage of the water-soluble polymer in the solid content is 43% by mass or greater, the oxygen gas barrier properties of the gas barrier laminated body after ill-treatment can be further improved as compared to the case where the content percentage of the water-soluble polymer in the solid content is less than 43% by mass.

The content percentage of the water-soluble polymer in the solid content may be less than 100% by mass; however, the content percentage is preferably 85% by mass or less, and more preferably 75% by mass or less. When the content percentage of the water-soluble polymer in the solid content is 85% by mass or less, the interlayer adhesion in the gas barrier laminated body 10 after a retort treatment can be further improved as compared to the case where the content percentage of the water-soluble polymer in the solid content is greater than 85% by mass. The content percentage of the water-soluble polymer in the solid content may be 70% by mass or less, 65% by mass or less, or 55% by mass or less.

The gas barrier coating layer-forming composition may further include a silane coupling agent as a curing agent.

The silane coupling agent is not particularly limited; however, it is preferable that the silane coupling agent is at least one selected from the group consisting of a silicon compound represented by the following General Formula (2) and a hydrolysate thereof.

(R²Si(OR³)₃)ₙ (2)

In the General Formula (2), R² represents a monovalent organic functional group, and R³ represents an alkyl group or —C₂H₄OCH₃.

In this case, it is possible to improve close adhesion between the gas barrier coating layer 4 and the metal oxide layer 3, and interlayer detachment (delamination) in the gas barrier laminated body 10 can be suppressed.

Incidentally, R² and R³ may be identical with or different from each other. R³'s may be identical with or different from each other.

As the monovalent organic functional group represented by R², a monovalent organic functional group containing a vinyl group, an epoxy group, a mercapto group, an amino group, or an isocyanate group may be exemplified. Above all, the monovalent organic functional group is preferably an isocyanate group. In this case, it is possible for the composition to have more excellent hot water resistance when cured, and greater lamination strength can be imparted to the gas barrier laminated body 10 even after a retort treatment.

Examples of the alkyl group represented by R³ include a methyl group and an ethyl group. Above all, a methyl group is preferred. In this case, hydrolysis proceeds rapidly.

n represents an integer of 1 or greater. When n is 1, the silane coupling agent represents a monomer, whereas when n is 2 or greater, the silane coupling agent represents a multimer. n is preferably 3. In this case, the hot water resistance of the gas barrier coating layer 4 can be further improved, and it is possible to impart greater lamination strength to the gas barrier laminated body 10 even after a retort treatment.

Examples of the silane coupling agent include silane coupling agents having a vinyl group, such as vinyltrimethoxysilane and vinyltriethoxysilane; silane coupling agents having an epoxy group, such as 3-glycidoxypropyltrimethoxysilane, 3-glycidoxypropyltriethoxysilane, 3-glycidoxypropylmethyldimethoxysilane, and 3-glycidoxypropylethyldiethoxysilane; silane coupling agents having a mercapto group, such as 3-mercaptopropyltrimethoxysilane and 3-mercaptopropylmethyldimethoxysilane; silane coupling agents having an amino group, such as 3-aminopropyltrimethoxysilane and 3-amniopropyltriethoxysilane; and silane coupling agents having an isocyanate group, such as 3-isocyanatopropyltriethoxysilane and 1,3,5-tris(3-methoxysilylpropyl) isocyanurate. These silane coupling agents may be used singly or in combination of two or more kinds thereof.

The content percentage of the silane coupling agent in the solid content is not particularly limited; however, the content percentage is preferably 3% by mass or greater, more preferably 5% by mass or greater, and particularly preferably 7% by mass or greater. In this case, greater lamination strength can be imparted, when cured, to the gas barrier laminated body 10 even after a retort treatment as compared to the case where the content percentage of the silane coupling agent in the solid content is less than 3% by mass.

The content percentage of the silane coupling agent in the solid content is preferably 20% by mass or less, more preferably 15% by mass or less, and particularly preferably 12% by mass or less. In this case, the silane coupling agent is less likely to bleed out, and contamination of the surface is suppressed, as compared to the case where the content percentage of the silane coupling agent in the solid content is greater than 20% by mass.

Incidentally, for example, in a case where the silane coupling agent is represented by the above-described General Formula (2), the content percentage of the silane coupling agent in the solid content is calculated by calculating the mass of the silane coupling agent in terms of the mass of R²Si(OH)₃. However, in a case where the silane coupling agent is represented by the above-described General Formula (2) and in a case where n is an integer of 2 or greater, the content percentage of the silane coupling agent in the solid content is calculated by calculating the mass of the silane coupling agent in terms of the mass of (R²Si(OH)₃)ₙ.

### (Other Components in Solid Content)

The solid content may further include known additives such as a dispersant, a stabilizer, a viscosity adjusting agent, and a coloring agent, as necessary to the extent that does not impair the gas barrier properties of the gas barrier coating layer 4.

### (Total Content Percentage of Components in Solid Content)

The total content percentage of the silicon alkoxide or a hydrolysate thereof, a water-soluble polymer, and a silane coupling agent in the solid content is not particularly limited; however, the total content percentage is usually 95% by mass or greater, and preferably 97% by mass or greater, or may be 100% by mass.

### (Liquid)

As a liquid for dissolving or dispersing the above-described solid content, an aqueous medium is usually used. The aqueous medium may be water, a hydrophilic organic solvent, or a mixture of these. Examples of the hydrophilic organic solvent include alcohols such as methanol, ethanol, and isopropanol; ketones such as acetone and methyl ethyl ketone; ethers such as tetrahydrofuran; cellosolves; carbitols; and nitriles such as acetonitrile. These can be used singly or in combination of two or more kinds thereof.

As the aqueous medium, an aqueous medium composed only of water, or an aqueous medium including water as a main component is preferred. In a case where the aqueous medium includes water as a main component, the content percentage of water in the aqueous medium is preferably 70% by mass or greater, and more preferably 80% by mass or greater.

The thickness of the gas barrier coating layer 4 is not particularly limited, and is preferably 50 nm or greater.

In this case, the oxygen barrier properties of the gas barrier laminated body 10 are further improved as compared to the case where the thickness of the gas barrier coating layer 4 is less than 50 nm. The thickness of the gas barrier coating layer 4 may be 60 nm or greater, 70 nm or greater, 80 nm or greater, or 90 nm or greater.

From the viewpoint of improving the gas barrier properties, the thickness of the gas barrier coating layer 4 is more preferably 100 nm or greater, and particularly preferably 200 nm or greater.

On the other hand, the thickness of the gas barrier coating layer 4 is preferably 700 nm or less. The flexibility of the gas barrier laminated body 10 further improves as compared to the case where the thickness of the gas barrier coating layer 4 is greater than 700 nm, and the oxygen barrier properties of the gas barrier laminated body 10 after ill-treatment can be further improved. In addition, the oxygen barrier properties of the gas barrier laminated body 10 after a retort treatment can also be further improved.

From the viewpoint of further improving flexibility of the gas barrier laminated body 10, the thickness of the gas barrier coating layer 4 is more preferably 500 nm or less, and particularly preferably 400 nm or less. The thickness of the gas barrier coating layer 4 may be 350 nm or less or 300 nm or less.

### <Method for Producing Gas Barrier Laminated Body>

Next, a method for producing the gas barrier laminated body 10 will be described.

First, a base material layer 1 is prepared.

Next, an anchor coat layer 2 is formed on one surface of the base material layer 1.

Specifically, an anchor coat layer 2 is formed by applying an anchor coat layer-forming composition for forming an anchor coat layer 2 on one surface of the base material layer 1 and drying the composition by heating. At this time, the heating temperature is, for example, 50 to 200° C., and the drying time is, for example, about 10 seconds to 10 minutes.

Next, a metal oxide layer 3 is formed on the anchor coat layer 2.

The metal oxide layer 3 can be formed by, for example, a vacuum film-forming method. Examples of the vacuum film-forming method include a physical vapor deposition method and a chemical vapor deposition method. Examples of the physical vapor deposition method include a vacuum deposition method, a sputter deposition method, and an ion plating method. As the physical vapor deposition method, a vacuum deposition method is particularly preferably used. Examples of the vacuum deposition method include a resistance heating type vacuum deposition method, an EB (Electron Beam) heating type vacuum deposition method, and an induction heating type vacuum deposition method. Examples of the chemical vapor deposition method include a thermal CVD method, a plasma CVD method, and a photo CVD method.

Next, a gas barrier coating layer 4 is formed on the metal oxide layer 3.

The gas barrier coating layer 4 can be formed by, for example, applying a gas barrier coating layer-forming composition on the metal oxide layer 3 and curing the composition. Here, the solid content being cured means that a silicon alkoxide or a hydrolysate thereof and a water-soluble polymer in the solid content, or a silicon alkoxide or a hydrolysate thereof, a water-soluble polymer, and a silane coupling agent in the solid content react with each other to be integrated.

As the method for applying the gas barrier coating layer-forming composition, any known method can be employed. Specific examples of the application method include wet film-forming methods such as a gravure coating method, a dip coating method, a reverse coating method, a wire bar coating method, and a die coating method.

Curing can be performed by, for example, heating or the like.

In a case where curing is performed by heating, the heating temperature and the heating time may be set such that curing of the solid content in the gas barrier coating layer-forming composition and removal of a liquid such as an aqueous medium can be performed simultaneously. The heating temperature may be set to, for example 80 to 250° C., and the heating time may be set to, for example, 3 seconds to 10 minutes.

The gas barrier laminated body 10 is obtained as described above.

### <Packaging Film>

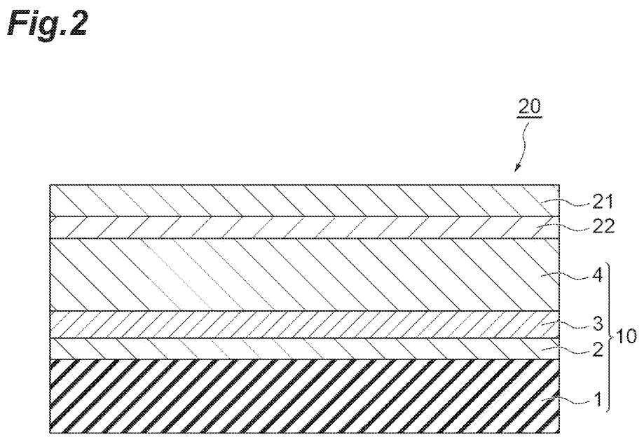

Next, an embodiment of a packaging film of the present disclosure will be described with reference to FIG. 2. In FIG. 2, the same constituent elements as those in FIG. 1 will be assigned with the same reference numerals, and any duplicate description will not be repeated here.

FIG. 2 is a cross-sectional view illustrating an embodiment of the packaging film of the present disclosure. As shown in FIG. 2, a packaging film 20 includes the gas barrier laminated body 10 and a sealant layer 21 laminated on the gas barrier laminated body 10, and the sealant layer 21 is disposed on the gas barrier coating layer 4 side of the base material layer 1 of the gas barrier laminated body 10. As shown in FIG. 2, in the gas barrier laminated body 10, the gas barrier coating layer 4 and the sealant layer 21 may be adhered by an adhesive layer 22.

Since this packaging film 20 includes the above-described gas barrier laminated body 10, the oxygen barrier properties after ill-treatment can be improved.

As the material of the adhesive layer 22, for example, a polyester-isocyanate-based resin, a urethane resin, and a polyether-based resin can be used. When the packaging film 20 is used for retort applications, a two-liquid curing type urethane-based adhesive having resistance to a retort treatment can be preferably used.

### (Sealant Layer)

As the material of the sealant layer 21, thermoplastic resins such as a polyolefin resin and a polyester resin may be exemplified, and a polyolefin resin is generally used. Specifically, as the polyolefin resin, ethylene-based resins such as a low-density polyethylene resin (LDPE), a medium-density polyethylene resin (MDPE), a linear low-density polyethylene resin (LLDPE), an ethylene-vinyl acetate copolymer (EVA), an ethylene-α-olefin copolymer, and an ethylene-(meth)acrylic acid copolymer; polypropylene-based resins such as a homopolypropylene resin (PP), a propylene-ethylene random copolymer, a propylene-ethylene block copolymer, and a propylene-α-olefin copolymer; mixtures of these, or the like can be used. The material of the sealant layer 21 can be selected as appropriate from among the above-mentioned thermoplastic resins depending on the use application and the temperature conditions of a boiling treatment, a retort treatment, and the like.

The thermoplastic resin constituting the sealant layer 21 may be stretched or may be unstretched; however, from the viewpoint of lowering the melting point and facilitating heat sealing, it is preferable that the thermoplastic resin is unstretched.

The thickness of the sealant layer 21 is determined as appropriate according to the mass of the contents, the shape of the packaging bag, and the like, and is not particularly limited; however, from the viewpoints of flexibility and adhesiveness of the packaging film 20, the thickness is preferably 30 to 150 μm.

### <Packaged Product>

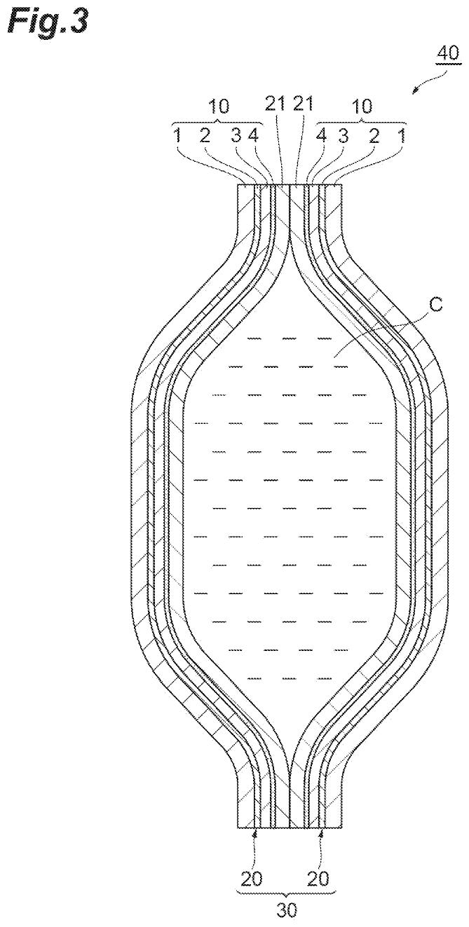

Next, an embodiment of a packaged product of the present disclosure will be described with reference to FIG. 3. Incidentally, FIG. 3 is a cross-sectional view illustrating an embodiment of the packaged product of the present disclosure. In FIG. 3, the same constituent elements as those in FIG. 1 or FIG. 2 will be assigned with the same reference numerals, and any duplicate description will not be repeated here.

As shown in FIG. 3, the packaged product 40 includes a packaging container 30 and contents C filled in the packaging container 30. The packaging container 30 shown in FIG. 3 is obtained by using a pair of packaging films 20 and heat-sealing the peripheral edges of the packaging films 20 in a state in which the sealant layers 21 face each other. In FIG. 3, the packaging film 20 is shown while the adhesive layer 22 is omitted.

This packaged product 40 includes the packaging container 30, and the packaging container 30 can improve the oxygen barrier properties after ill-treatment, deterioration of the quality of the contents C caused by oxygen contamination can be suppressed over a long period of time.

The packaging container 30 is also obtained by folding one sheet of the packaging film 20 and heat-sealing the peripheral edges of the packaging film 20 in a state in which the sealant layers 21 face each other.

Examples of the packaging container 30 include a packaging bag, a laminated tube container, and a liquid paper container.

The contents C are not particularly limited, and examples of the contents C include foods, liquids, pharmaceutical products, and electronic components.

The present disclosure is not limited to the above-described embodiments. For example, in the above-described embodiments, the sealant layer 21 is disposed on the gas barrier coating layer 4 side of the base material layer 1 of the gas barrier laminated body 10 in the packaging film 20; however, the sealant layer 21 may also be disposed on the side of the base material layer 1 facing away from the gas barrier coating layer 4.

### EXAMPLES

Hereinafter, the present disclosure will be specifically described by way of Examples; however, the present disclosure is not intended to be limited to these Examples.

### <Preparation of Coating Liquid>

Coating liquids 1 to 8 as gas barrier coating layer-forming compositions used in Examples or Comparative Examples were prepared as follows.

### (Coating Liquid 1)

A solution (hydrolyzed solution of TEOS) obtained by mixing tetraethoxysilane (trade name: KBE04, solid content: 100%, manufactured by Shin-Etsu Chemical Co., Ltd.; hereinafter, also referred to as “TEOS”) as a silicon alkoxide, methanol (Kanto Chemical), and 0.1 N hydrochloric acid (manufactured by KANTO CHEMICAL CO., INC.) at a mass ratio of 45/15/40 and hydrolyzing the mixture, and a 5% by mass aqueous solution of polyvinyl alcohol (trade name: KURARAY POVAL 60-98, manufactured by Kuraray Co., Ltd.; hereinafter, also referred to as “PVA”) were mixed, and a coating liquid 1 was obtained. The coating liquid 1 was prepared such that when the solid content was taken as 100, the mass ratio of TEOS (value calculated in terms of SiO₂) and PVA was 40/60.

### (Coating Liquid 2)

The hydrolyzed solution of TEOS used in the above-described coating liquid 1, the 5% by mass aqueous solution of PVA used in the coating liquid 1, and a solution obtained by diluting and adjusting 1,3,5-tris(3-methoxysilylpropyl) isocyanurate as a silane coupling agent (SC agent) with a mixed solution at a mass ratio of water/IPA=1/1 such that the proportion of the solid content was 5% (mass ratio, calculated in terms of R²Si(OH)₃), and a coating liquid 2 was obtained. The coating liquid 2 was prepared such that when the solid content was taken as 100, the mass ratio of TEOS (value calculated in terms of SiO₂), isocyanurate silane (value calculated in terms of R²Si(OH)₃), and PVA was 40/5/55. Incidentally, since 1,3,5-tris(3-methoxysilypropyl) isocyanurate is a trimer, the phrase calculated in terms of R²Si(OH)₃ specifically means that the mass of 1,3,5-tris(3-methoxysilylpropyl) isocyanurate is calculated in terms of the mass of (R²Si(OH)₃)₃.

### (Coating Liquids 3 to 8)

Coating liquids 3 to 8 were prepared in the same manner as in the case of the coating liquid 2, except that when the solid content was taken as 100, the mass ratio or the mass proportion (unit: %) of TEOS (value calculated in terms of SiO₂), isocyanurate silane (value calculated in terms of R²Si(OH)₃), and PVA was changed as shown in Table 1 or Table 2.

### <Preparation of Anchor Coat Layer-Forming Composition>

An anchor coat layer-forming composition was prepared as follows.

Acrylic polyol and tolylene diisocyanate were mixed such that the number of NCO groups of tolylene diisocyanate was equal to the number of OH groups of acrylic polyol, and the mixture was diluted with ethyl acetate such that the solid content (total amount of acrylic polyol and tolylene diisocyanate) was 5% by mass. To the diluted mixed liquid, β-(3,4-epoxycyclohexyl)trimethoxysilane was further added such that the amount thereof was 5 parts by mass with respect to 100 parts by mass of the total amount of acrylic polyol and tolylene diisocyanate, and these were mixed to prepare the anchor coat layer-forming composition (anchor coating agent).

### <Fabrication of Gas Barrier Laminated Body>

### Example 1

A gas barrier laminated body was fabricated as follows by a roll-to-roll method. First, a polyethylene terephthalate film (trade name “P60”, manufactured by Toray Industries, Inc.) as a base material layer having a thickness of 12 μm was mounted on an unwinding apparatus, a conveyance apparatus, and a winding apparatus.

Next, the base material layer was continuously fed, and on the base material layer during conveyance, an AlOₓ film (metal oxide layer) was formed such that the film thickness was 12 nm. At this time, the formation of the AlO-film was performed by using an electron beam heating type vacuum deposition apparatus, and introducing oxygen so as to adjust the pressure to 1.2×10⁻² Pa while evaporating an aluminum ingot by electron beam heating.

The coating liquid 1 was applied on this AlOₓ film and dried by heating to form a gas barrier coating layer having a thickness of 350 nm as shown in Table 1. At this time, the heating was performed such that the liquid in the coating liquid 1 was removed while TEOS and PVA constituting the solid content in the coating liquid 1 were cured to form a cured body. At this time, specifically, the heating temperature was set to 90° C.

As described above, a gas barrier laminated body in which a base material layer, a metal oxide layer, and a gas barrier coating layer were laminated in this order was obtained.

For the gas barrier laminated body obtained in this way, the ratio (Si/C) of carbon atoms with respect to silicon atoms was determined by XPS as follows.

That is, Si/C obtained by XPS was determined by using the following measurement instrument, acquiring a spectrum by performing a narrow analysis under the following measurement conditions, and calculating the ratio (molar ratio) of Si and C from this spectrum. The results are shown in Table 1.

### <Measurement Instrument>

Manufactured by JEOL Ltd., model JPS-9030 photoelectron spectrometer

### <Measurement Conditions>

### (Spectrum Collection Conditions)

Incident X-rays: MgKα (monochromatized X-rays, hν=1253.6 eV)

X-ray output: 10 W (10 kV·10 mA)

X-ray scanning area (measurement region): Circular region having a diameter of 6 mm

Photoelectron uptake angle: 90°

### Example 2

A gas barrier laminated body was fabricated as follows by a roll-to-roll method. First, a polyethylene terephthalate film (trade name “P60”, manufactured by Toray Industries, Inc.) as a base material layer having a thickness of 12 μm was mounted on an unwinding apparatus, a conveyance apparatus, and a winding apparatus.

Next, on one surface of the base material layer during conveyance, the anchor coat layer-forming composition prepared as described above was applied by a gravure coating method to form a coating film. Then, the coating film was heated at 120° C. for 10 seconds and dried to obtain an anchor coat layer having a thickness of 25 nm, and a laminated body was obtained. The laminated body obtained in this way was wound up by using a winding apparatus, and a roll-shaped laminated body was obtained.

Next, the roll-shaped laminated body was mounted on an unwinding apparatus, a conveyance apparatus, and a winding apparatus. Then, the laminated body was continuously unwound from the roll-shaped laminated body, and on the anchor coat layer of the laminated body during conveyance, an AlO, film (metal oxide layer) was formed to have a thickness of 12 nm. At this time, the formation of the AlOₓ film was performed by using an electron beam heating type vacuum deposition apparatus, and introducing oxygen so as to adjust the pressure to 1.2×10⁻² Pa while evaporating an aluminum ingot by electron beam heating.

The coating liquid 2 was applied on this AlO, film and dried by heating to form a gas barrier coating layer having a thickness of 350 nm as shown in Table 1. At this time, the heating was performed such that the liquid in the coating liquid 2 was removed while TEOS, PVA, and isocyanurate silane constituting the solid content in the coating liquid 2 were cured to form a cured body. At this time, specifically, the heating temperature was set to 90° C.

As described above, a gas barrier laminated body in which a base material layer, an anchor coat layer, a metal oxide layer, and a gas barrier coating layer were laminated in this order was obtained.

For the gas barrier laminated body obtained in this way, the Si/C was determined by XPS in the same manner as in Example 1. The results are shown in Table 1.

### Examples 3 to 27 and Comparative Examples 1 to 5

Gas barrier laminated bodies were fabricated in the same manner as in Example 2, except that the configurations of the base material layer, the anchor coat layer, the metal oxide layer, and the gas barrier coating layer were adjusted as shown in Table 1 or Table 2. In a case where the metal oxide layer was formed of SiOₓ, silicon dioxide as a SiO vapor deposition material was used instead of the aluminum ingot to be evaporated by electron beam heating. In addition, in Table 1 or Table 2, the term “OPP” used for the base material layer indicates a polypropylene resin film (trade name “U-1”, biaxially stretched film, manufactured by Mitsui Chemicals Tohcello, Inc.) having a thickness of 25 μm.

For the gas barrier laminated bodies obtained in this way, the Si/C was determined by XPS in the same manner as in Example 1. The results are shown in Table 1 or Table 2.

### <Evaluation of Gas Barrier Laminated Body>

For the gas barrier laminated bodies obtained in Examples 1 to 27 and Comparative Examples 1 to 5, the oxygen barrier properties after ill-treatment and the oxygen barrier properties after a retort treatment were evaluated by XPS as follows.

### (1) Fabrication of Laminate Film

First, in order to perform the above-described evaluations, laminate films were fabricated as follows.

That is, an unstretched polypropylene film (CPP, trade name “TORAYFAN ZK207”, manufactured by TORAY ADVANCED FILM Co., Ltd.) having a thickness of 60 μm was stuck onto the surface of the base material layer of each of the gas barrier laminated bodies obtained in Examples 1 to 27 and Comparative Examples 1 to 5, by using a two-liquid type adhesive (trade name “TAKELAC A-525/TAKENATE A-52” manufactured by Mitsui Chemicals, Inc.), and thereby a laminate film having a surface width of 210 mm was fabricated.

### (2) Measurement of Oxygen Permeability

For the above-described laminate film, the oxygen permeability (unit: cc/m²·day·atm) was measured as the initial oxygen permeability under the conditions of a temperature of 30° C. and a relative humidity of 70%, by using an oxygen permeability measurement apparatus (product name “OX-TRAN2/20”, manufactured by MOCON, Inc.). At this time, the measurement was performed according to JIS K-7126-2. The results are shown in Table 1 and Table 2.

(3) Oxygen Barrier Properties after Ill-Treatment

The above-described laminate film was subjected to ill-treatment by performing a bending test (Gelbo Flex test) and a stretching test as follows, and the oxygen permeability after ill-treatment (that is, oxygen permeability after bending and oxygen permeability after stretching) were measured in the same manner as in the measurement of the initial oxygen permeability as described above. The results are shown in Table 1 and Table 2.

### (Bending Test)

The bending test was performed as follows.

A test sample A having a size of 297 mm in length×210 mm in width was cut out from the above-described laminate film, and this test sample A was attached to a fixing head of a Gelbo Flex tester (manufactured by TESTER SANGYO CO., LTD.) so that the laminate film had a cylindrical shape with a size of a diameter of 87.5 mm×210 mm, and a cylindrical body was produced. Then, both ends of the cylindrical body were held, a reciprocating movement of repeatedly performing an operation of applying a 440-degree twist while setting the initial grip interval to 175 mm and the stroke to 87.5 mm, was performed 10 times at a rate of 40 times/min, and the cylindrical body was bent.

### (Stretching Test)

The stretching test was performed as follows.

A test sample B having a size of 200 mm in length×150 mm in width was cut out from the above-described laminate film, and the test sample B was stretched 5% in the vertical direction at a speed of 100 μm/second by using a Tensilon manufactured by Toyo Baldwin Co., Ltd., the state was maintained for 1 minute, and then the test sample B was returned to its original position at the same speed.

The acceptance criteria for the oxygen barrier properties after ill-treatment were as follows.

### (Acceptance Criteria)

Acceptable . . . The oxygen permeability after bending was 15 cc/m²·day·atm or less, and the oxygen permeability after stretching was 2 cc/m²·day·atm or less.

Unacceptable . . . The oxygen permeability after bending was greater than 15 cc/m²·day·atm, the oxygen permeability after stretching was greater than 2 cc/m²·day·atm, or both are satisfied.

(4) Oxygen Permeability after Retort Treatment

### (Fabrication of Test Sample)

In order to perform evaluation of the oxygen barrier properties after a retort treatment, a test sample C was fabricated as follows.

First, a three-sided pouch with an opening was fabricated by using a laminate film fabricated as described above. At this time, the three-sided pouch was formed by folding the laminate film such that the unstretched polypropylene films faced each other, and subjecting the unstretched polypropylene films to thermal fusion bonding. Then, a sealed body was prepared by pouring tap water (city water) through the opening and sealing the opening of the three-sided pouch, and this sealed body was used as the test sample C.

### (Retort Treatment)

The test sample C obtained as described above was subjected to a heating treatment at 121° C. for 30 minutes (retort treatment). Then, the oxygen permeability after the retort treatment was measured in the same manner as in the measurement of the above-mentioned initial oxygen permeability. The results are shown in Table 1 and Table 2.

TABLE 1

| | Base | | | | | | | | | | | | Oxygen permeability | | | |
|---|---|---|---|---|---|---|---|---|---|---|---|---|---|---|---|---|
| | material | | Anchor | | Metal oxide | | Gas barrier coating layer | | | | | | (cc/m² · day · atm) | | | |
| | layer | | coat layer | | layer | | | Mass proportion of | | | | | | | | After |
| | | Thick- | Presence | Thick- | | Thick- | Coat- | solid content (%) | | | Thick- | | | After ill-treatment | | retort |
| | | ness | or | ness | | ness | ing | TEOS | SC | | ness | | | After | After | treat- |
| | Type | (μm) | absence | (nm) | Type | (nm) | liquid | (SiO₂) | agent | PVA | (nm) | Si/C | Initial | bending | stretching | ment |
| Example 1 | PET | 12 | Absent | — | AlOx | 12 | 1 | 40 | 0 | 60 | 350 | 0.28 | 0.4 | 3.4 | 0.8 | 0.5 |
| Example 2 | PET | 12 | Present | 25 | AlOx | 12 | 2 | 40 | 5 | 55 | 350 | 0.31 | 0.3 | 2.8 | 0.6 | 0.4 |
| Example 3 | PET | 12 | Present | 50 | AlOx | 12 | 1 | 40 | 0 | 60 | 350 | 0.28 | 0.3 | 2.5 | 0.5 | 0.4 |
| Example 4 | PET | 12 | Present | 50 | AlOx | 12 | 2 | 40 | 5 | 55 | 350 | 0.31 | 0.2 | 1.8 | 0.5 | 0.3 |
| Example 5 | PET | 12 | Present | 50 | SiOx | 25 | 1 | 40 | 0 | 60 | 350 | 0.28 | 0.2 | 1.8 | 0.5 | 0.4 |
| Example 6 | PET | 12 | Present | 50 | SiOx | 25 | 2 | 40 | 5 | 55 | 350 | 0.31 | 0.3 | 2.1 | 0.6 | 0.4 |
| Example 7 | PET | 12 | Present | 50 | SiOx | 25 | 3 | 5 | 0 | 95 | 350 | 0.12 | 0.1 | 0.9 | 0.3 | 0.3 |
| Example 8 | PET | 12 | Present | 50 | SiOx | 25 | 4 | 55 | 5 | 40 | 350 | 0.48 | 0.4 | 6.8 | 0.9 | 0.7 |
| Example 9 | OPP | 20 | Absent | — | AlOx | 12 | 2 | 40 | 5 | 55 | 350 | 0.31 | 0.7 | 7.8 | 1.2 | 2.2 |
| Example 10 | OPP | 20 | Present | 50 | AlOx | 12 | 2 | 40 | 5 | 55 | 350 | 0.31 | 0.5 | 6.4 | 0.9 | 1.0 |
| Example 11 | OPP | 20 | Present | 50 | AlOx | 12 | 3 | 5 | 0 | 95 | 350 | 0.12 | 0.1 | 1.2 | 0.2 | 0.4 |
| Example 12 | OPP | 20 | Present | 50 | AlOx | 12 | 4 | 55 | 5 | 40 | 350 | 0.48 | 0.2 | 14.5 | 1.4 | 2.1 |
| Example 13 | OPP | 20 | Present | 50 | SiOx | 25 | 1 | 40 | 0 | 60 | 350 | 0.28 | 0.3 | 4.6 | 0.6 | 0.8 |
| Example 14 | OPP | 20 | Present | 50 | SiOx | 25 | 2 | 40 | 5 | 55 | 350 | 0.31 | 0.4 | 5.7 | 0.8 | 0.9 |
| Example 15 | OPP | 20 | Present | 100 | SiOx | 25 | 1 | 40 | 0 | 60 | 350 | 0.28 | 0.2 | 2.1 | 0.4 | 0.7 |
| Example 16 | OPP | 20 | Present | 100 | SiOx | 25 | 2 | 40 | 5 | 55 | 350 | 0.31 | 0.1 | 1.8 | 0.4 | 0.7 |

TABLE 2

| | Base | | | | | | | | | | | | Oxygen permeability | | | |
|---|---|---|---|---|---|---|---|---|---|---|---|---|---|---|---|---|
| | material | | Anchor | | Metal | | Gas barrier coating layer | | | | | | (cc/m² · day · atm) | | | |
| | layer | | coat layer | | oxide layer | | | Mass proportion of | | | | | | | | After |
| | | Thick- | Presence | Thick- | | Thick- | Coat- | solid content (%) | | | Thick- | | | After ill-treatment | | retort |
| | | ness | or | ness | | ness | ing | TEOS | SC | | ness | | | After | After | treat- |
| | Type | (μm) | absence | (nm) | Type | (nm) | liquid | (SiO₂) | agent | PVA | (nm) | Si/C | Initial | bending | stretching | ment |
| Example 17 | OPP | 20 | Present | 100 | SiOx | 25 | 3 | 5 | 0 | 95 | 350 | 0.12 | 0.1 | 1.5 | 0.4 | 0.6 |
| Example 18 | OPP | 20 | Present | 100 | SiOx | 25 | 4 | 55 | 5 | 40 | 350 | 0.48 | 0.2 | 12.4 | 0.9 | 1.1 |
| Example 19 | OPP | 20 | Present | 100 | SiOx | 25 | 5 | 10 | 5 | 85 | 350 | 0.16 | 0.1 | 1.8 | 0.5 | 0.7 |
| Example 20 | OPP | 20 | Present | 100 | SiOx | 25 | 6 | 20 | 5 | 75 | 350 | 0.21 | 0.1 | 2.2 | 0.5 | 0.8 |
| Example 21 | OPP | 20 | Present | 100 | SiOx | 25 | 7 | 52 | 5 | 43 | 350 | 0.43 | 0.2 | 9.8 | 0.8 | 1.0 |
| Example 22 | OPP | 20 | Present | 100 | SiOx | 4 | 2 | 40 | 5 | 55 | 350 | 0.31 | 0.8 | 13.8 | 1.5 | 2.4 |
| Example 23 | OPP | 20 | Present | 100 | SiOx | 85 | 2 | 40 | 5 | 55 | 350 | 0.31 | 0.1 | 10.8 | 1.8 | 0.6 |
| Example 24 | OPP | 20 | Present | 100 | SiOx | 25 | 2 | 40 | 5 | 55 | 45 | 0.31 | 0.3 | 11.2 | 0.8 | 2.5 |
| Example 25 | OPP | 20 | Present | 100 | SiOx | 25 | 2 | 40 | 5 | 55 | 720 | 0.31 | 0.1 | 8.7 | 1.2 | 0.4 |
| Example 26 | OPP | 50 | Present | 100 | SiOx | 25 | 2 | 40 | 5 | 55 | 350 | 0.31 | 0.1 | 5.6 | 0.7 | 0.9 |
| Example 27 | OPP | 20 | Present | 200 | SiOx | 25 | 2 | 40 | 5 | 55 | 350 | 0.31 | 0.1 | 1.5 | 0.5 | 0.7 |
| Comparative | PET | 12 | Present | 50 | AlOx | 12 | 8 | 61 | 0 | 39 | 350 | 0.52 | 0.2 | 18.2 | 2.1 | 0.8 |
| Example 1 | | | | | | | | | | | | | | | | |
| Comparative | PET | 12 | Present | 50 | SiOx | 25 | 8 | 61 | 0 | 39 | 350 | 0.52 | 0.1 | 17.9 | 2.2 | 0.7 |
| Example 2 | | | | | | | | | | | | | | | | |
| Comparative | OPP | 20 | Present | 50 | AlOx | 12 | 8 | 61 | 0 | 39 | 350 | 0.52 | 0.2 | 20.5 | 1.9 | 3.1 |
| Example 3 | | | | | | | | | | | | | | | | |
| Comparative | OPP | 20 | Present | 50 | SiOx | 25 | 8 | 61 | 0 | 39 | 350 | 0.52 | 0.3 | 18.4 | 1.8 | 2.9 |
| Example 4 | | | | | | | | | | | | | | | | |
| Comparative | OPP | 20 | Present | 100 | SiOx | 25 | 8 | 61 | 0 | 39 | 350 | 0.52 | 0.2 | 17.6 | 1.3 | 3.0 |
| Example 5 | | | | | | | | | | | | | | | | |

As shown in Tables 1 and 2, the gas barrier laminated bodies of Examples 1 to 27 showed sufficiently low values of the oxygen permeability after ill-treatment, as compared with the gas barrier laminated bodies of Comparative Examples 1 to 5.

From the above description, it was verified that the gas barrier laminated body of the present disclosure can improve the oxygen barrier properties after ill-treatment.

### REFERENCE SIGNS LIST

1: base material layer, 3: metal oxide layer, 4: gas barrier coating layer, 10: gas barrier laminated body, 20: packaging film, 21: sealant layer, 30: packaging container, 40: packaged product.

1. A gas barrier laminated body, comprising:
a base material layer including a thermoplastic resin;
a metal oxide layer; and
a gas barrier coating layer, in this order,
wherein on a surface of the gas barrier coating layer, a ratio (Si/C) of silicon atoms and carbon atoms as measured by X-ray photoelectron spectroscopy is greater than 0 and less than 0.50.

2. The gas barrier laminated body according to claim 1, further comprising an anchor coat layer between the base material layer and the metal oxide layer.

3. The gas barrier laminated body according to claim 1,
wherein the gas barrier coating layer is formed from a cured body of a composition including a water-soluble polymer and at least one selected from a group consisting of a silicon alkoxide represented by a General Formula (1) and a hydrolysate thereof, and
in the composition, when an amount of the silicon alkoxide is calculated in terms of SiO₂, a content percentage of the water-soluble polymer in a solid content is 40% by mass or greater,
Si(OR¹)₄ (1)
wherein in the General Formula (1), R¹ represents an alkyl group or —C₂H₄OCH₃.

4. The gas barrier laminated body according to claim 3, wherein in the composition, when the amount of the silicon alkoxide is calculated in terms of SiO₂, the content percentage of the water-soluble polymer in the solid content is greater than 43% by mass and 85% by mass or less.

5. The gas barrier laminated body according to claim 1,
wherein the gas barrier coating layer further includes a silane coupling agent,
the silane coupling agent includes at least one selected from a group consisting of a silicon compound represented by a General Formula (2) and a hydrolysate thereof,
(R²Si(OR³)₃)ₙ (2)
wherein in the General Formula (2), R² represents a monovalent organic functional group; R³ represents an alkyl group or —C₂H₄OCH₃; and n represents an integer of 1 or greater.

6. The gas barrier laminated body according to claim 1, wherein the metal oxide layer has a thickness of 5 nm or greater and 80 nm or less.

7. The gas barrier laminated body according to claim 1, wherein the gas barrier coating layer has a thickness of 50 nm or greater and 700 nm or less.

8. The gas barrier laminated body according to claim 2, wherein the anchor coat layer has a thickness of 30 nm or greater and 300 nm or less.

9. The gas barrier laminated body according to claim 1, wherein the base material layer has a thickness of 40 μm or less.

10. A packaging film comprising the gas barrier laminated body according to claim 1 and a sealant layer.

11. A packaging container comprising the packaging film according to claim 10.

12. A packaged product comprising the packaging container according to claim 11 and contents filled in the packaging container.
